(19) United States
(12) Patent Application Publication
(10) Pub. No.: US 2014/0369569 A1
(43) Pub. Date: Dec. 18, 2014

(54) Printed Authentication Pattern for Low Resolution Reproductions

(71) Applicant: Document Security Systems, Inc., Rochester, NY (US)

(72) Inventors: David Wicker, Dansville, NY (US); Michael Caton, Oakfield, NY (US); Nicole Acton, Churchville, NY (US)

(21) Appl. No.: 14/304,880

(22) Filed: Jun. 13, 2014

Related U.S. Application Data
(60) Provisional application No. 61/834,799, filed on Jun. 13, 2013.

(51) Int. Cl. B42D 25/378; G06K 9/00; G06T 7/00; B42D 25/30

(52) U.S. Cl. CPC B42D 25/378; B42D 25/30; G06K 9/00463; G06T 7/0008; G06T 7/001; B42D 2035/12; B42D 2035/24; G06T 2207/10004; G06T 2207/30144
USPC 382/112; 283/85

(57) ABSTRACT

A document includes an authenticity-indicating feature configured such that a reproduction of the document renders the printed feature visually distinctive from an original rendering of the document. The printed feature includes printed elements arranged on the substrate in a latent image region and a background region. The printed elements in the latent image region include a plurality of regularly spaced printed shapes arranged with a spatial frequency less than about 50 per inch. The printed elements are printed with a carbon-based ink, toner, or dye, and separated from one another by contrasting regions that do not include the carbon-based ink, toner, or dye. The printed elements in the background region are at least partially surrounded by the latent image region such that, in the original rendering of the document, the plurality of regularly spaced printed shapes is not readily distinguishable from the background.

### CROSS-REFERENCE TO RELATED APPLICATIONS

This application claims priority to U.S. Provisional Patent Application No. 61/834,799, filed Jun. 13, 2013, which is incorporated herein by reference in its entirety and for all purposes.

### BACKGROUND

Unless otherwise indicated herein, the materials described in this section are not prior art to the claims in this application and are not admitted to be prior art by inclusion in this section.

Documents may be reproduced by copying, scanning, or otherwise imaging the documents and printing a reproduction based on the captured image. Some documents have an associated tangible value, such as documents used to negotiate transactions, including financial documents, checks, currency, certificates of deposit, titles to property, coupons, certificates, and so on. Authenticating such documents may include determining whether a document is an authentic original or an unauthorized reproduction. Unauthorized reproductions may also be referred to as forged or counterfeit documents.

A variety of printing technologies can be used to create printed documents, including intaglio printing processes, offset printing processes, laser jet or ink jet printing technologies in order to arrange ink, toner, or another dye on a document substrate in accordance with a specified pattern.

### SUMMARY

An authenticity-indicating region of a printed document includes a latent image printed with a field of regularly spaced shapes printed using a high carbon-content ink. The shapes are arranged at a line frequency less than about 50 per inch. The combination causes the latent image to become apparent in a reproduction made using a typical archival scanner that scans documents at a resolution of 72 dots per inch, for example. A non-authentic reproduction can be identified by both appearance of the latent image, and deformation of the individual regularly spaced printed shapes. For instance, corners of the squares may be rounded or otherwise malformed in reproductions.

In some examples, a document may be authenticated using a computer-implemented system that obtains an image of a document and analyzes the image to determine whether the document is authentic. The computing system may include image analysis modules that are configured to determine whether the individual shapes in the latent image region correspond to an original version of the document or a reproduction thereof. For instance, the computing system may estimate a degree of deformation of the shapes and then determine whether the document is authentic based on the degree of deformation. The degree of deformation may be based, for example, on a degree of correspondence between a shape in the imaged document and a shape used when creating an original version of the document.

### BRIEF DESCRIPTION OF THE DRAWINGS

The accompanying drawings, which are incorporated into this specification, illustrate one or more example embodiments disclosed herein and, together with the detailed description, serve to explain the principles and example implementations of the present disclosure. One of skill in the art will understand that the drawings are illustrative only, and that what is depicted therein may be adapted based on the text of the specification and the spirit and scope of the teachings herein.

FIG. 1 illustrates an original document including a latent image printed with a field of square elements.

FIG. 2A illustrates a reproduction of the original document shown in FIG. 1.

FIG. 2B illustrates another reproduction of the original document shown in FIG. 1.

FIG. 3 is a flowchart of an example computer-implemented process for document authentication.

FIG. 4A is a simplified block diagram of an example system for document authentication.

FIG. 4B is a simplified block diagram of an example computing system for document authentication based on an image.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

### I. Example Authenticity-Indicating Printed Feature

One approach for identifying unauthorized reproductions is to configure a document with latent images that are not readily apparent in the original, but which become apparent in a reproduction. Some latent images can be rendered in patterns that are not readily apparent on an original, but which are differentially reproduced via scanning technologies relative to a background surrounding the latent image. The appearance of the latent image on a reproduction of the original document thus provides a visual cue that the document being examined is not authentic. Similarly, lack of appearance of such a latent image (i.e., on a document in which latent images, if present, are not readily apparent) provides a visual cue that the document being examined is authentic.

Disclosed herein are certain printed patterns for arranging printed elements on a substrate to form a latent image. The pattern is arranged such that the latent image becomes apparent in a reproduction of the original document, but is substantially indistinguishable from the surrounding areas of the document in an original version of the document. Such reproduction-apparent latent images are also referred to herein as authenticity-indicating printed features (or reproduction-altered printed features), because a document bearing a visually distinctive rendering of such a latent image can thereby be readily identified as a reproduction as opposed to an original version, and thus authentic version.

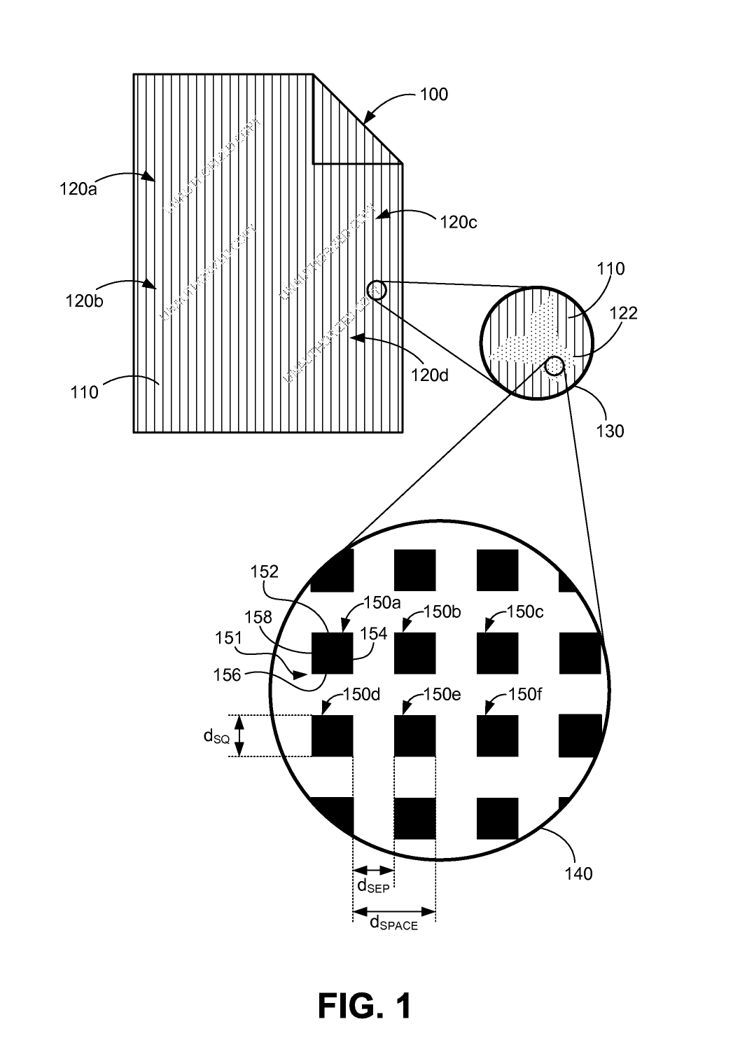

FIG. 1 illustrates an original document 100 including a latent image printed with a field of square elements. The document 100 may be a paper-based substrate (e.g., formed from paper fibers), a plastic-based substrate (e.g., formed of a polymeric material such as teslin or the like), or another substrate suitable for disposing ink, toner, dye, or other printing material so as to create a pattern on the substrate arranged as disclosed herein. As shown in FIG. 1, the document 100 includes a background setting 110 and one or more latent images 120a-d. In the example shown in FIG. 1, the latent images 120a-d occupy regions arranged in a series of alphanumeric characters so as to spell out a warning phrase (e.g., a phrase such as “UNAUTHORIZED COPY”). However, the latent images 120a-d may be additionally or alternatively arranged to occupy regions forming alternative shapes and/or characters. For example purposes, FIG. 1, depicts document 100 as being entirely covered by the background setting 110. In some examples, however, the background setting 110 in which the latent images 120a-d are rendered may occupy only a portion of the entire document 110. For instance, some documents may be configured such that a border around a perimeter of the document includes an authenticity-indicating feature and a central region of the document does not. In addition, the regions of the individual latent images 120a-d are illustrated as being approximately evenly spaced across the document 100 so as to allow any given portion of the document 100 that includes at least one of the latent images 120a-d (or a subsection thereof) to be authenticated as an original (i.e., distinguished from a reproduction).

An intermediate view 130 of a portion of the latent image 120d shows a “Y” character 122. The “Y” character 122 is surrounded by the background setting 110. The “Y” character 122 is illustrated for purposes of explanation and understanding in the intermediate view 130 by a cross-hatched pattern that at least approximately complements the visual appearance (e.g., as influenced by color, tint, print density, etc.) of the background setting 110.

A. Latent Image Including Regularly Spaced Printed Shapes

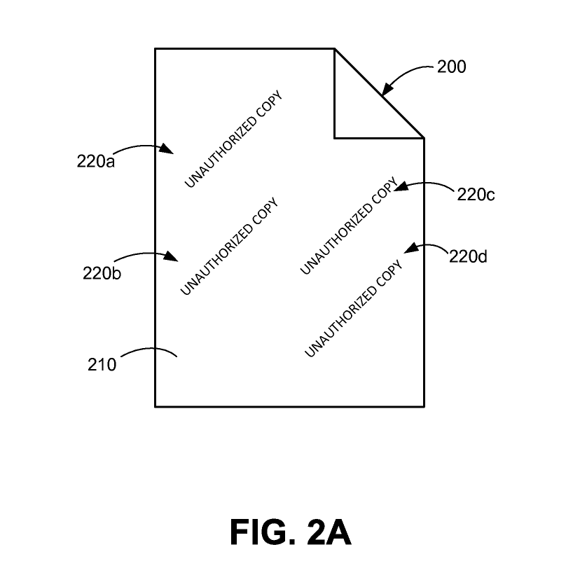

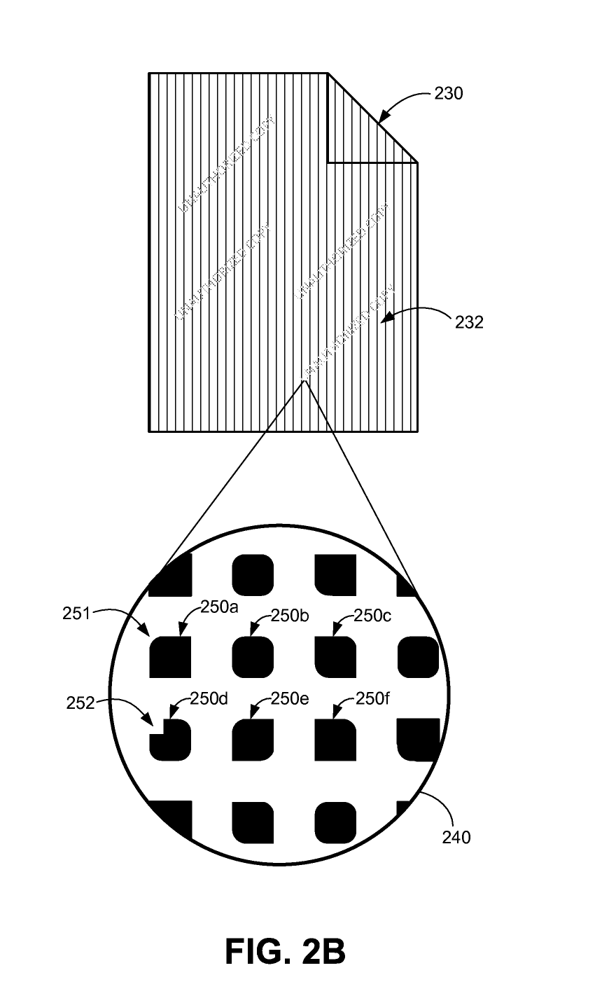

An enhanced view 140 illustrates a portion of the “Y” character 122. As shown in the enhanced view 140, the “Y” character is formed by a two-dimensional array of regularly spaced shapes 150a-f. Each of the shapes 150 can be substantially identical. The shapes 150 are illustrated by way of example as four-sided shapes, and in particular as square shapes. However, shapes with alternative geometries may be employed, such as circles, triangles, pentagons, hexagons, etc. An example square shape 150 has a top side 152, an opposing bottom side 156 that is substantially parallel to the top side 152, and two substantially parallel opposing sides 158, 154 that connect the top side 152 and bottom side 156, respectively. The sides 152-158 of the square shape 150 meet at four perpendicular corners (e.g., the right-angle corner 151). Other shapes may have corners other than right-angle corners, such as corners on stars, hexagons, triangles, pentagons, etc. Additionally or alternatively, shapes occupying the region of the latent image can include other high spatial-frequency features other than corners, such as points, curves, etc. Such corners and/or other high spatial frequency features provide an additional authenticity-identifying feature similar to micro-printing, because fine, detailed, and/or high spatial frequency features of such shapes are not precisely and/or accurately rendered in a reproduction of the original. As such, a reproduction can be identified as non-original by examining distortions and/or deformations in corners and/or other fine features of the shapes in the region occupied by the latent image. For instance, in a reproduction at least one of the shapes can be compared with a shape associated with an original version of the document (i.e., a precisely formed square such as example shape 150). The extent of deviation from the precise square shape, in the analyzed reproduction, can be used as a basis for determining whether the analyzed document is an authentic original or a reproduction. These effects are discussed further in connection with FIG. 2 below.

B. Spatial Frequency of Printed Shapes

The shapes 150a-f can be arranged in a regularly spaced two-dimensional array. For example, adjacent ones of the shapes 150a-f can be separated by the same amount both vertically and horizontally (e.g., the shapes 150a, 150d can be separated by the same distance as the shapes 150a, 150b). In some examples, the arrangement of shapes can be spaced apart from one another with a spatial frequency of about 45 shapes per inch (18 per centimeter). In some examples, the arrangement of shapes can be spaced apart from one another with a spatial frequency between about 40 shapes per inch and about 50 shapes per inch (16 per centimeter and about 20 per centimeter). In some examples, the arrangement of shapes can be spaced apart from one another with a spatial frequency less than about 65 shapes per inch (26 shapes per centimeter). As used herein, “shapes per inch” refers to the number of shapes encountered along a straight line with a length of one inch. The inter-element spacing (e.g., the distance between a common point on two adjacent ones of the shapes 150a-f, which is labeled d_{SPACE} on FIG. 1) is thus at least approximately 1/45 of an inch (1/18 of a centimeter), or in the range of about 1/50 of an inch and about 1/40 of an inch (1/20 of a centimeter and 1/16 of a centimeter).

The region between the shapes 150a-f in the latent image can be a non-printed region. Separating the individual shapes 150a-f by non-printed regions (e.g., regions absent of any printed elements) increases the contrast between the individual shapes 150a-f and the immediately surrounding region that separates the shapes 150a-f from one another.

In some examples, the spatial frequency of the shapes 150a-f is selected to be below a typical scanning frequency of a low-resolution scanner, such as an archival scanner that samples scanned documents at about 72 dots per inch (28 dots per centimeter). By employing a spatial resolution less than the spatial sampling frequency of an archival scanner, the pattern of shapes 150a-f can be detected by an archival scanner. By contrast, printed authentication features that use arrangements of printed elements arranged with a spatial frequency greater than an archival scanner, (e.g., line screen patterns with line frequencies greater than about 100) may be substantially ignored by such a low-resolution scanner, because the resolution forces the scanner to integrate over fine features, and authenticity-indicating functionality may therefore fail to perform on such scanners (e.g., printed patterns which are differentially reproduced when scanned at 300 dpi may not be differentially reproduced at 72 dpi, because the line screen patterns responsible for the differential reproduction are simply integrated over by the low resolution scanner).

C. High-Carbon Content Ink, Toner, or Dye

In examples in which the shapes 150a-f are printed with ink, the ink can be an ink with a relatively high carbon content, or another additive that prevents the dye in the ink from being diluted by being absorbed into the substrate of the document 100. With reference to the PANTONE® Color Guide, one such example black is 908. The black ink desirably includes sufficient carbon (or another additive) to prevent at least some of the ink disposed on the substrate from readily absorbing into the paper fiber substrate of the document 100. For example, the carbon content can cause at least some of colored solvent in the water-based ink to be disposed on the surface of the paper substrate, rather than absorbed into the paper fibers. Because the ink disposed on the surface of the substrate is not diluted due to the absorption, the resulting pattern of printed shapes has a high contrast with the immediately surrounding area (e.g., the region between the printed shapes 150a-f).

Another exemplary black is black magnetic toner used to print Magnetic Ink Character Recognition (MICR) such as on banking numbers along the bottom of checks, for example. Similar to high carbon-content ink, at least some of the MICR ink or toner is not readily absorbed into the fibers paper-based substrate due to iron content (or other metallic/magnetic additive). In either case, the additive prevents at least some of the ink/toner from being absorbed into the paper and results in a top coating of non-absorbed ink/toner residing on the surface of the substrate of the document 100. Printing with an ink having carbon, metal, and/or magnetic additives thereby results in a pattern with high contrast relative to the immediately surrounding region of the arrangement of shapes (e.g., the region between the shapes 150a-f).

The ink is also a color that maximizes contrast with the area surrounding the printed shapes 150a-f, which may be a non-printed region. Thus, on white paper, the ink is preferably black, but may be another dark color, such as a blue, green, purple, red. In some examples, the area between the printed shapes 150a-f may be printed with one or more inks, toners, or dyes that are different from the high carbon content ink. In practice, if any print elements are included in the region between the regularly spaced shapes 150a-f, such print elements are rendered in a color and/or ink that provides a high degree of contrast with the ink used for the printed shapes 150a-f. In some examples, the ink is selected such that an archival black/white scanner perceives regions printed with the ink as black. Such a scanner may also perceive regions (e.g., surrounding areas) as white.

D. Print Density

The print density of the latent image (e.g., the “Y” character 122) is determined, at least in part, by the relative size of the shapes and the space in between the shapes. For example, the sides of the square shape 150 may have a length dimension d_{SQ}, and may be separated from adjacent squares by the distance d_{SEP}, as shown in FIG. 1. The print density can then be determined based on the fractional total surface area that is occupied by the shapes 150a-f, relative to the space between the shapes. In some examples, dimension d_{SQ} may be in a range from about 0.005 inches to about 0.007 inches (127 micrometers to 178 micrometers). In some examples, dimension d_{SQ} may in be a range from about 0.0045 inches to about 0.008 inches (114 micrometers to 203 micrometers). The inter-element spacing distance d_{SEP} may be about 0.015 inches (381 micrometers), for example. In some examples, the inter-element spacing distance may be in a range from about 0.012 inches to about 0.020 inches (304 micrometers to 508 micrometers). In some examples, the inter-element spacing distance may be in a range from about 0.012 inches to about 0.025 inches (304 micrometers to 635 micrometers). In an example with a spatial frequency of 45 shapes per inch (18 shapes per centimeter), a 10% print density can be achieved with regularly spaced substantially identical squares having dimension d_{SQ} 0.005 inches (127 micrometers); a 12% print density can be achieved with regularly spaced substantially identical squares having dimension d_{SQ} 0.0055 inches (140 micrometers); a 15% print density can be achieved with regularly spaced substantially identical squares having dimension d_{SQ} 0.0065 inches (165 micrometers); and a 20% print density can be achieved with regularly spaced substantially identical squares having dimension d_{SQ} 0.007 inches (178 micrometers). Other examples are also possible, including examples at other spatial frequencies, with alternative shapes, and/or at other print densities, although similar scaling relationships and dimension tradeoffs may be encountered with respect to shape dimensions and print density.

In some cases, rather than regularly spaced individual shapes, a pattern of regularly spaced substantially parallel line segments can occupy a region to create a latent image that is reproduced differentially relative to the background 110. The pattern of regularly spaced, substantially parallel line segments can be referred to herein as a line screen pattern. In some examples, a line screen pattern may have lines with thickness in a range from about 0.001 inches to about 0.003 inches (25 micrometers to 76 micrometers). In some examples, a line screen pattern may have lines with thickness in a range from about 0.001 inches to about 0.0035 inches (25 micrometers to 89 micrometers). The lines may be separated by an inter-line separation distance of about 0.013 inches (330 micrometers), for example. In some examples, the inter-line separation distance may be in a range from about 0.010 inches to about 0.016 inches (254 micrometers to 406 micrometers). In some examples, the inter-line separation distance may be in a range from about 0.010 inches to about 0.020 inches (254 micrometers to 508 micrometers). In an example with line screen patterns with line frequencies of about 70-80 lines per inch (28-31 lines per centimeter) can be selected to provide a complementary print density to the arrayed shape patterns discussed herein, a 10% print density can be achieved by lines having thickness of 0.001 inches (25 micrometers); a 12% print density can be achieved by lines having thickness of 0.002 inches (51 micrometers); a 15% print density can be achieved by lines having thickness of 0.0025 inches (64 micrometers); and a 20% print density can be achieved by lines having thickness of 0.003 inches (76 micrometers). Other examples are also possible, including examples at other line frequencies, line thicknesses, and/or at other print densities, although similar scaling relationships and dimension tradeoffs may be encountered with respect to line thickness and print density. The complementary print densities of the line screen patterns can then be included on the same document 100 as the pattern of regularly spaced shapes forming the latent image without the latent image being readily distinguishable from the background.

E. Background Setting

For purposes of facilitating explanation and understanding only, the background setting 110 is illustrated in FIG. 1 by a pattern of vertical lines. However, the background setting 110 can be arranged in a variety of different ways. The background setting 110 may include a pattern of printed elements arranged in a line screen, for example, or a randomized or pseudo randomized arrangement of printed elements situated to create a visually integrated background setting for the latent images 120a-d. The background setting 110 can be printed in a color, hue, and/or print density that complement the printed elements used to form the latent images 120a-d such that the latent images are not readily discernible to the naked eye on an original version of document 100. In some examples, an ink, toner, or dye used to print the print elements of the background setting 110 may be different from that used to print the regularly spaced printed shapes (or other features) of the latent images 120a-d. For example, the ink, toner, or dye used in the background setting 110 may not include a significant amount of carbon or other additive that mitigates absorption into the substrate of the document, and thereby dilutes the color of the ink.

The background setting may also include an arrangement of distributed printed dots, which may be distributed in random or pseudo random fashion so as to have print densities similar to print densities of the shape pattern and/or line screen patterns included on the document. The similar print density of such a dot pattern thereby creates a visually integrated background setting for the latent images 120a-d. For example, the background setting 110 may include dots with diameters of about 0.002 inches (51 micrometers) that are distributed to be separated from one another by about 0.006 inches (152 micrometers). In some cases, the inter-element spacing of about 0.006 (152 micrometers) inches may be an average inter-element spacing between nearest neighbors in a pseudo-randomly distributed field of printed dots. In an example with a dot pattern selected to provide a complementary print density to the arrayed shape patterns discussed herein, a 10% print density can be achieved by dots having diameters about 0.002 inches (51 micrometers); a 12% print density can be achieved by dots having diameters about 0.002 inches (51 micrometers); a 15% print density can be achieved by dots having diameters about 0.0025 inches (64 micrometers); and a 20% print density can be achieved by dots having diameters about 0.003 inches (76 micrometers). Other examples are also possible, including examples at other spatial frequencies, dot sizes, and/or at other print densities, although similar scaling relationships and dimension tradeoffs may be encountered with respect to line thickness and print density.

The background setting 110 may or may not overlap with the region forming the latent images 120a-d (e.g., the region forming the “Y” character in FIG. 1). In examples in which the background setting 110 does overlap with the region forming the latent images 120a-d, the contrast of the individual shapes 150a-f may be relatively decreased.

Further, as noted above, the background setting 110, in which the latent images 120a-d are embedded, may or may not occupy the entirety of the document 110. In particular, the background setting 110, and one or more latent images, which together form an authenticity-indicating printed feature may be included on a particular region of the document 100 that is less than the entire printable surface, such as a border, a defined section, or a more than one non-continuous regions of the document 100.

### II. Identification of Reproductions

As noted above, the printed authenticity-indicating features can be used to distinguish between an original, and thus authentic, document, and a non-original reproduction of such document. In practice, the authenticity-indicating features described in connection with FIG. 1 are configured so as to be reproduced by conventional reproduction systems in a manner that can be readily detected by human visual perception and/or by computer-implemented image analysis.

A. Readily Distinguishable Latent Image(s)

FIG. 2A illustrates a reproduction 200 of the original document 100 shown in FIG. 1. The reproduction 200 includes latent image 220a-d which are readily distinguishable from the background setting 210. For example, the latent images 220a-d may become readily distinguishable in the reproduction 200 because the background setting 110 of the original is occupied by an arrangement of printed elements having a higher nominal spatial frequency than the scanning frequency of the reproduction technology used to create the reproduction 200 (e.g., a scanner, copier, etc.). In such an example, the background setting 210 of the reproduction 200 is rendered substantially free of printed content. On the other hand, the latent images 220a-d, which were rendered with an arrangement of regularly spaced shapes printed with contrasting ink on the original document 100 (e.g., ink including carbon, iron or another additive) may be rendered as a substantially solid field in the shape of the latent images 220a-d. In some examples, the shapes printed with a high contrast ink at a spatial frequency less than the scanning frequency of an archival scanner causes the archival scanner to render the latent images 220a-d discernible in the reproduction 200.

B. Distinguishable by Deformation of Spaced Printed Shapes

FIG. 2B illustrates another reproduction 230 of the original document 100 shown in FIG. 1. The reproduction 230 may be created with a high resolution scanner, such as a 300-600 dpi scanner, which is able to reproduce the pattern of regularly spaced shapes forming the latent images 120a-d in the original document 100. However, the fine details of the individual shapes (e.g., high spatial frequency features such as corners) are not accurately rendered in the reproduction 230. The enhanced view 240 illustrates the array of shapes 240a-f in the reproduction 230 in the region of the reproduced latent image 232. The array of shapes 240a-f are not an accurate reproduction of the corners of the squares from the original document 100. In particular, at least some of the corners are rounded (e.g., the corner 251 of shape 250a). Some of the corners (or other fine features of the original shapes 150a-f) may also be malformed in the reproduced shapes 250a-f. For example, the shape 250d includes a cut-out malformation 252 rather than a right-angle corner as on the original version. The presence of the malformations and/or rounded corners in the reproduced document 230 can be used to indicate that the document 230 is not an original and is rather an unauthorized copy.

Similarly, observing accurately formed corners and/or other fine features of the shapes 150a-f in the original document 100 can thus allow for the document 100 to be authenticated as an original. The authentication process can be similar to that used to authenticate a document on the basis of the presence of micro-printed text, which is not accurately reproduced. Authentication may require use of a magnifying visual aid in some cases.

### III. Computer-Implemented Document Authentication System

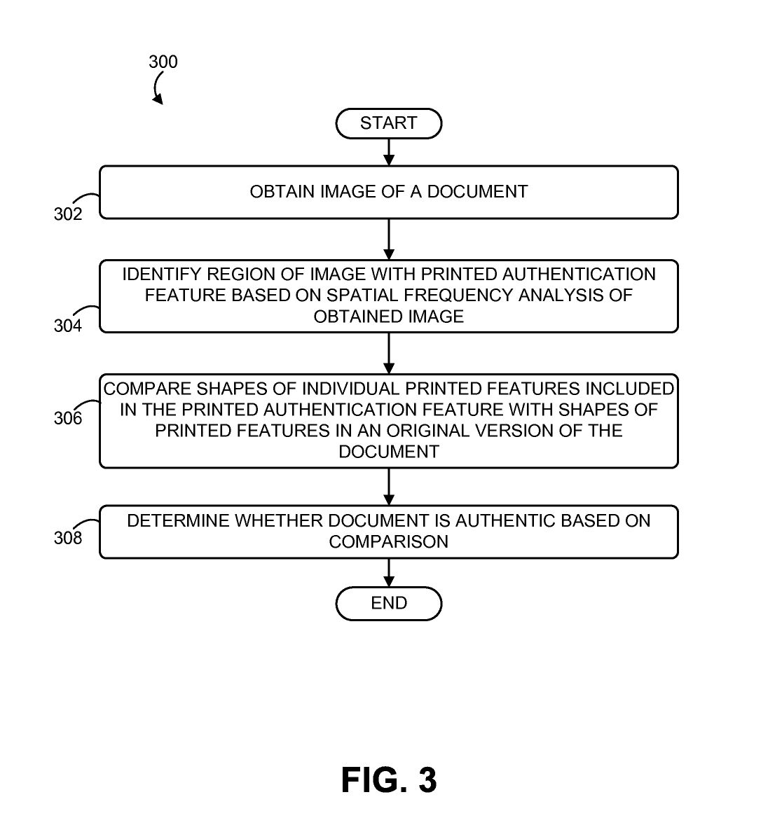

FIG. 3 is a flowchart of an example computer-implemented process 300 for document authentication. The process 300 can be performed to determine whether a document including the authenticity-indicating features described herein is an authentic original document, or rather a reproduction. In general, the process 300 involves identifying the regularly spaced printed shapes that are included in the latent image regions of the document. The process 300 can then determine whether the document is authentic based on the shape of the printed shapes (e.g., the extent of deformation of the printed shapes). In some examples, the process 300 may be performed in whole or in part in accordance with software-implemented functional modules (e.g., program instructions executed by a processing system). Additionally or alternatively, one or more of the operations involved in the process 300 may be performed in whole or in part by firmware-implemented and/or hardware-implemented functional modules, including logical circuitry and/or purpose-built circuits (e.g., application-specific integrated circuits, etc.). In some cases, any of the processing functions described herein may be performed using a single computing platform and/or a combination of computing platforms that coordinate processes in part by communicating via a network.

At block 302, an image of a document can be obtained. For example, a document may be imaged using a flat bed scanner, a pass-through scanner that detects reflected light from the document using an array of light-sensitive elements. Alternatively, the document may be imaged using a device equipped with a camera, such as a mobile device (e.g., smart phone), a hand-held camera, a camera incorporated in a laptop computer, a hand-held scanner used in a retail environment for scanning/recognizing coded items, or another device operable to generate a digital representation of the document by measuring light reflected from the document and incident on a light-sensitive electronic array. In some examples, a hand-held mobile device or scanner may be used to image the document and generate the digital image.

At block 304, a region of the obtained image with the printed authentication feature can be identified based in part on a spatial frequency analysis of printed features on the imaged document. In some cases, such as examples in which an image is obtained from a hand-held scan, an image processing system may identify, within the obtained image, the document (e.g., using edge detection of edges of the document, pattern recognition of particular printed features, etc.). The image processing system can then characterize the spatial frequency of printed features amongst different regions of the imaged document. The spatial frequency analysis may involve, for example, segmented spatial frequency analysis of the printed features of the document (e.g., Fourier analysis of printed features, etc.). The printed authentication feature may then be identified based on one (or more) of the analyzed region(s) having a spatial frequency corresponding to a spatial frequency of printed shapes/lines used in printing the printed authentication feature.

In some cases, the spatial frequency analysis (and printed authentication feature identification) may involve a pattern recognition analysis in which a particular region of the document is identified that includes printed shapes and/or lines that are regularly spaced in an arrangement similar to the arrangement of printed elements in the latent image regions 120a-d of the authenticity-indicating feature, for example. Thus, the image processing system may be configured to search for a particular pattern/arrangement of printed elements/shapes that correspond to the latent image region used for a particular authenticity-indicating feature (e.g., an array of regularly spaced shapes of a given size and spacing).

At block 306, the shapes of individual printed features in the printed authentication feature depicted in the identified region are compared with corresponding shapes in an original version of the document. For instance, the computing system may estimate a degree of correspondence between the shapes in the identified region of the image, and the original shapes. In an example in which the regularly spaced shapes in the original document are squares, block 306 may involve determining a degree of deformation from the square shape for one or more of the shapes in the identified region. The comparison of block 306 may be focused, in particular, on finely detailed and/or high-frequency aspects of the regularly spaced shapes on the original version of the document. For example, the comparison may involve comparing the corners of the shapes and/or estimating a degree of deformation of the corners of the shapes in the identified region of the image. Estimating the degree of deformation (or degree of correspondence) may involve, for example, evaluating a percentage and/or number of deformed corners or other high-frequency features amongst the printed shapes. A given feature may be determined to be deformed if the computing system determines a given portion of the imaged shape (e.g., a corner) lacks more than a threshold amount of printed surface area, when compared to an original version of the shape. For instance, at least some of the deformed/rounded corners of the shapes 250a-f depicted in FIG. 2B may be determined to lack more than a threshold amount of printed surface area around the corners, in comparison to a corresponding shape found in an original version (e.g., a square with sharply defined right-angle corners).

At block 308, the computing system can determine whether the document is authentic based on the comparison between the shapes. For example, the computing system may evaluate a degree of correspondence between the shapes in the identified latent image region and the shape of regularly spaced printed shapes included in an original version. The authenticity determination can then be based on the degree of correspondence exceeding a threshold or not. Moreover, in some cases, the authenticity determination may be based on multiple factors related to the comparison of block 306 (e.g., a total number or percentage of deformations and an average degree of those deformations exceeding a threshold).

Once the authenticity determination is made in block 308, an indication of that determination can be generated by the computing system. The generated indication can then be used to provide an output to a user of the computer-implemented authentication system, for example. In some cases, data indicative of the generated indication may be encoded in a data transmission and transmitted to another computing system, or data indicative of the generated indication may be communicated by a user interface system (e.g., a display, etc.).

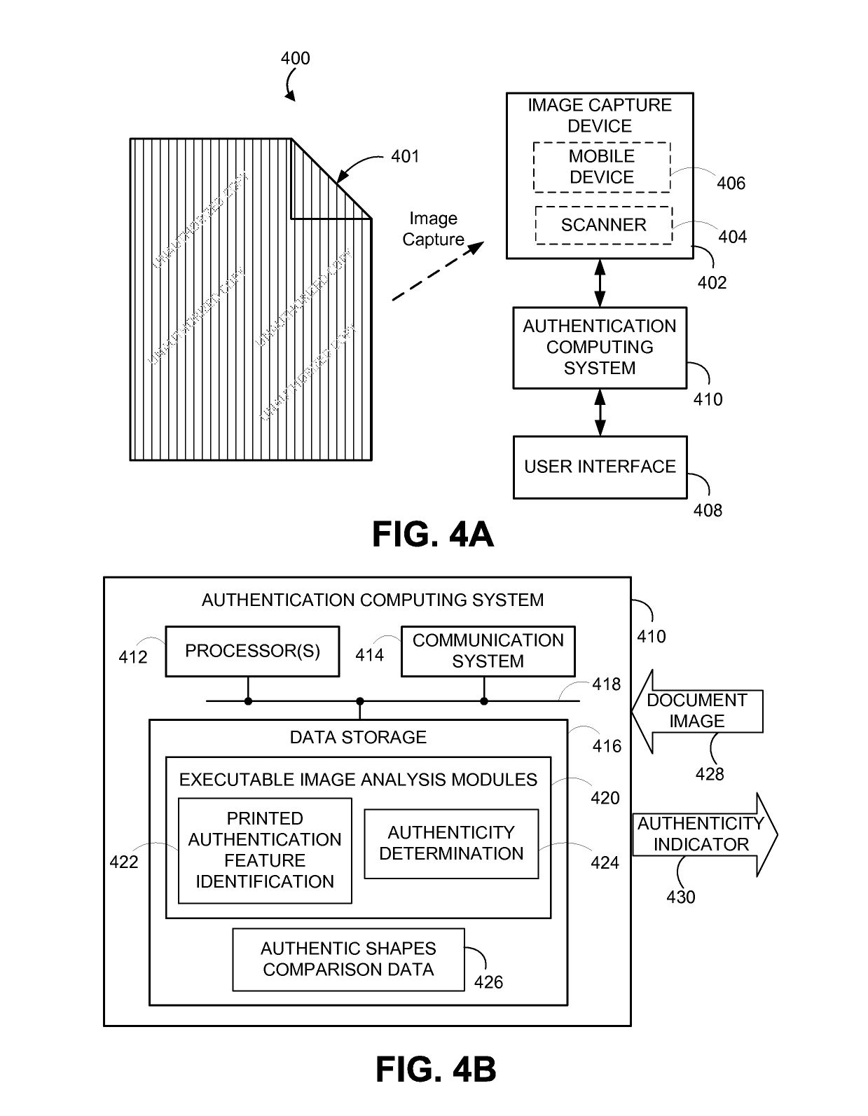

FIG. 4A is a simplified block diagram of an example system 400 for document authentication. The system 400 includes an image capture device 402, an authentication computing system 410, and a user interface 408. The image capture device 402 may include a mobile imaging device 404, such as a smart phone, tablet or the like having an integrated camera, or may include a hand-held scanner similar to those used in retail sales environment, for example. The image capture device 402 may additionally or alternatively include a scanner 406, such as a flatbed scanner or pass-through scanner which detects reflected light from a document using an array of light-sensitive element. Other imaging systems may also be used. The image capture device 402 functions to obtain a digital image that includes the document 401, and provide the image to the authentication computing system 410. In some examples, the image capture device may operate in response to a user input, such as depressing a button or interacting with a touchscreen interface on a camera, for example.

The authentication computing system 410 can be in communication with the image capture device 402 (to receive captured images). The authentication computing system 410 may perform one or more of the functions described in connection with FIG. 3 and is also described in further detail in connection with FIG. 4B.

The user interface 408 is also in communication with the authentication computing system 410 and may function to receive inputs from users (e.g., an indication to initiate an authentication process) and also provide outputs to users (e.g., providing an indication of authenticity of a given document following performance of an authentication process). Thus, the user interface may include one or more user input devices, such as monitors, touchscreens, voice inputs, buttons, etc., and also one or more user output devices, such as speakers, displays, haptic feedback systems, indicator lights, etc. In some examples, the user interface may include a display system that displays indications of whether or not a given is document following completion of an authentication process using the authentication computing system 410.

FIG. 4B is a simplified block diagram of the example authentication computing system 410 for document authentication. The authentication computing system 410 includes one or more general purpose or special purpose processor(s) 412 (e.g., microprocessors, digital signal processors, etc.), communication system(s) 414, and memory 416, all communicatively linked by a bus, network, or other connection system 418. The memory 416 can include executable program instructions 420 (e.g., program code) that can be executed using the processor(s) 412 to cause the authentication computing system 410 to perform functions specified by the instructions 420. The program instructions 420 can be organized in a variety of different ways, and may include one or more functional modules (e.g., software packages). For instance, the executable instructions 420 can include a printed authentication feature identification module 422, which functions to identify a region of an image that includes a printed authentication feature based in part on a spatial frequency analysis and/or pattern recognition analysis of printed features on an imaged document. The functions performed by the printed authentication feature identification module 422 may be the same or similar to the function(s) of process 300 described in connection with block 304. The executable instructions 420 can also include an authenticity determination module 424, which functions to determine whether a given document is authentic based on an analysis of one or more individual printed shapes making up an identified printed authentication. The authenticity determination module 424 may function to compute an extent of correspondence between analyzed shapes and shapes specified by authentic shapes comparison data 426 (or degree of deformation of such shapes relative to the authentic shapes comparison data 426), and then determine authenticity based on the computed extent of correspondence. The functions performed by the printed authenticity determination module 424 may be the same or similar to the function(s) of process 300 described in connection with blocks 306 and/or 308. The authentic shapes comparison data 426 may include data that specifies the shape(s) of the regularly spaced printed shapes in a latent image region of a printed authentication feature. As such, the authentic shapes comparison data 426 can be used by the authenticity determination module 424 when making a comparison with the shapes in the identified region of the imaged document.

As shown in FIG. 4B, the authentication computing system 410 receives digital image data 428 (e.g., from the image capture device 402), and responsively generates an indication 430 of the authenticity of the document in the digital image. The generated indication 430 may specify alternately: (i) that the imaged document is authentic, (ii) that the imaged document is not authentic, or (iii) that the authenticity cannot be determined, perhaps because the image quality is insufficient or due to another factor.

### IV. Additional Embodiments

In some examples, the background surrounding the latent image (e.g., the background setting 110) can include additional anti-counterfeiting features, such as a field that includes a latent image in a visually integrated background setting. The latent image can be embedded in the background setting and indistinguishable from the background in an original printed version of the document. In some embodiments, the latent image can be distinguishable in a reproduction of the original printed version so as to verify an authenticity to an original printed version of the document by distinguishing the original printed version from the reproduction. In some embodiments, the latent image can be distinguishable in an original printed version of the document via a specialized viewer or visual aid configured to differentially interfere with the latent image or the background surrounding the latent image. The latent image can be indistinguishable in a reproduction of the original printed version so as to provide authenticity to the authenticated registration document by distinguishing the original printed version from the reproduction. In some embodiments, the latent image and/or the integrated background setting can be composed of line-screen patterns of printed elements oriented with selected line frequencies, print densities, colors, etc. to achieve the desired effects. Furthermore, the specialized viewer or visual aid can have a characteristic line frequency corresponding to a line frequency of a line screen pattern of the latent image or the background such that the latent image is distinguishable from the background in the original printed version by differential interference patterns between the latent image and the background. Examples of some embedded security features are disclosed, for example, in commonly assigned U.S. patent application Ser. No. 11/839,657, filed Aug. 16, 2007, published as U.S. Patent Publication No. 2008/0048433 on Feb. 28, 2008, and issued as U.S. Pat. No. 8,444,181, issued May 21, 2013; U.S. patent application Ser. No. 11/744,840, filed May 5, 2007, and published as U.S. Patent Publication No. 2007/0257977 on Nov. 8, 2007; and U.S. patent application Ser. No. 11/495,900, filed Jul. 31, 2006, and published as U.S. Patent Publication No. 2007/0029394, the contents of each of which are hereby incorporated herein by reference in their entireties.

Accordingly, in some embodiments, the background of the printed pattern forming the latent image is a reproduction altered security feature. As used herein, the term “reproduction altered” is used to describe a printed field having a foreground and a background which, when reproduced, causes the foreground and background to be altered with respect to one another in the reproduction relative to their relationship in an original version of the printed field. Thus, the inability to distinguish the latent image from the visually integrated setting can indicate an original, whereas distinguishing the latent image from the visually integrated setting can indicate a reproduction, which may therefore be an unauthorized copy (e.g., a counterfeit or unauthentic document).

Such a background surrounding the printed pattern forming the latent image and including an embedded security feature itself thus provides a multi-layered anti-counterfeiting feature. For example, in addition to the square pattern latent image described herein, which operate particularly well at relatively low scanning frequencies such as employed by archival scanners (e.g., 72 dpi), additional authenticity-indicating features can be included that are tuned or are otherwise known to be performant at other scanning frequencies (e.g., 300-600 dpi). For example, some reproduction devices, copy machines, etc., may indicate a counterfeit document by one of the authenticity-indicating features being activated, but not another. As a result, the integrated multi-layered anti-counterfeiting feature can result in activation of at least one of several authenticity-indicating features across a broad range of scanners, copiers, and other reproduction technologies, including those that operate at different scanning resolutions. The latent image and/or the background setting can be rendered as, for example, one or more line screen patterns that are distinguishable in a copy and can include characters to spell out a warning phrase, such as, for example, “Unauthorized Copy,” “Void,” etc.

In some embodiments, an embedded security feature in the background and/or printed pattern forming latent image(s) described herein can include a latent image that is not readily distinguishable from its surrounding background in an original printed version, but which becomes distinguishable in a reproduction of the original. As used herein, a reproduction generally refers to a physical copy of an original printed document reproduced using optical scanning technologies. In some embodiments, the embedded security feature can include a latent image that is not readily distinguishable from its surroundings in an original printed version, but which becomes distinguishable in an electronic display (“visual facsimile”) of an optically scanned version of the original printed document.

In some embodiments, the elements in the security pattern can be printed with ultraviolet (UV) or infrared (IR) inks (i.e., inks configured to selectively reflect or emit UV or IR light). Some photocopiers and other digital reproduction devices have been found to be sensitive to UV and/or IR inks and anti-copying features have been activated in at least some digital reproduction devices by security patterns printed with UV and/or IR inks

According to some embodiments, elements of this disclosure may be used to authenticate a variety of documents and related products, including but not limited to the following: protection/secondary authentication of product codes on product packaging (such as verification of destination country for pharmaceutical products), authentication of unique or expensive goods (such as signed memorabilia), control of imports/exports (such as for luxury goods commonly counterfeited), warehouse management and tracking (such as the destination information and expiration date of perishable items), authentication of important documents such as ID cards or title documents, verification of promotional materials or gaming tickets, identification of product recalls, and many other applications relying on the authentication, via a smart device, of hidden security information within a document.

Many functions described herein may be implemented in hardware, firmware, or software. Further, software descriptions of the disclosure can be used to produce hardware and/or firmware implementing the disclosed embodiments. According to some embodiments, software and/or firmware may be embodied on any known non-transitory computer-readable medium having embodied therein a computer program for storing data. In the context of this disclosure, computer-readable storage may be any tangible medium that can contain or store data for use by, or in connection with, an instruction execution system, apparatus, or device. For example, a non-volatile computer-readable medium may store software and/or firmware program logic executable by a processor to achieve one or more of the functions described herein in connection with FIGS. 1-4. Computer-readable storage may be, for example, an electronic, magnetic, optical, electromagnetic, infrared, or semiconductor system, apparatus, or device, or any suitable combination of the foregoing. More specific examples of computer-readable storage would include but are not limited to the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. Further, although aspects of the present disclosure have been described herein in the context of a particular implementation in a particular environment for a particular purpose, those of ordinary skill in the art will recognize that its usefulness is not limited thereto and that the present disclosure can be beneficially implemented in any number of environments for any number of purposes.

In view of the exemplary systems described above, methodologies that may be implemented in accordance with the described subject matter will be better appreciated with reference to the various figures. For simplicity of explanation, the methodologies are depicted and described as a series of acts. However, acts in accordance with this disclosure can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be appreciated that the methodologies described in this disclosure are capable of being stored on an article of manufacture to facilitate transporting and transferring such methodologies to computing devices.

Although some of various drawings illustrate a number of logical stages in a particular order, stages which are not order dependent can be reordered and other stages can be combined or broken out. Alternative orderings and groupings, whether described above or not, can be appropriate or obvious to those of ordinary skill in the art of computer science. In addition, some logical stages may be omitted entirely in a given implementation. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to be limiting to the precise forms disclosed. Many modifications and variations are possible in view of the above teachings. The embodiments were chosen and described in order to best explain the principles of the aspects and its practical applications, to thereby enable others skilled in the art to best utilize the aspects and various embodiments with various modifications as are suited to the particular use contemplated.

What is claimed is:

1. A document comprising:
a substrate; and
an authenticity-indicating printed feature configured such that a reproduction of the document renders the printed feature visually distinctive from an original version of the document, the printed feature including printed elements arranged on the substrate in a latent image region and a background region,
wherein the printed elements in the latent image region include a plurality of regularly spaced printed shapes arranged with a spatial frequency less than about 50 per inch, wherein the plurality of printed shapes are printed with a carbon-based ink, toner, or dye, and wherein the plurality of regularly spaced printed shapes are separated from one another by contrasting areas that do not include the carbon-based ink, toner, or dye, and
wherein the printed elements in the background region at least partially surround the latent image region such that the latent image region is not readily visually distinguishable from the background in the original document.

2. The document of claim 1, wherein the contrasting areas are non-printed areas of the substrate.

3. The document of claim 1, wherein the contrasting areas include a pattern of printed elements that are not printed with the carbon-based ink, toner, or dye.

4. The document of claim 1, wherein the plurality of regularly spaced printed shapes are separated from one another by a distance approximately equal to a dimension of each printed shape.

5. The document of claim 1, wherein the plurality of regularly spaced printed shapes are arranged with a spatial frequency between about 40 per inch and about 50 per inch.

6. The document of claim 5, wherein the plurality of printed shapes are arranged with a spatial frequency of about 45 per inch.

7. The document of claim 1, wherein the plurality of regularly spaced printed shapes are arranged in a two-dimensional array.

8. The document of claim 1, wherein the plurality of regularly spaced printed shapes are substantially identical to one another.

9. The document of claim 1, wherein at least one of the plurality of regularly spaced printed shapes includes a shape with a corner at which perpendicular sides of the shape meet.

10. The document of claim 9, wherein the at least one printed shape is a square or a rectangle.

11. The document of claim 9, wherein the corner is not accurately rendered in the reproduction of the document, thereby providing a visually distinctive printed feature.

12. The document of claim 1, wherein the printed elements in the background region include elements printed in a color selected from a group including blue, green, red, purple, and black.

13. The document of claim 1, wherein the background region at least partially overlaps the latent image region.

14. The document of claim 1, wherein the carbon-based ink, toner, or dye with which the plurality of regularly spaced printed shapes are printed is different from one or more other inks, toners, or dyes with which printed elements in the background region are printed, and wherein the carbon-based ink, toner, or dye is absorbed into the substrate of the document less than the one or more other inks, toners, or dyes.

15. A method comprising:
obtaining an image of a document;
identifying, via a computing system analyzing the obtained image, a particular region of the document having a printed authentication feature based on a spatial frequency of printed features in the particular region;
comparing a shape of at least one of a plurality of regularly spaced printed shapes within the identified particular region with a shape associated with an authentic version of the document;
making a determination of authenticity of the imaged document based at least in part on the comparison; and
generating an indication of the determination.

16. The method of claim 15,
wherein comparing the shape comprises determining a degree of correspondence between one or more corners of the shape and one or more corners of the shape associated with the authentic version of the document, and
wherein making the determination of authenticity comprises making the determination of authenticity based at least in part on the estimated degree of correspondence.

17. The method of claim 15, further comprising:
displaying, via a display system, data indicative of the generated indication.

18. A system comprising:
an imaging system configured to obtain an image of a document;
a user interface; and
a computing system configured to: (i) use the imaging system to obtain an image of a given document; (ii) identifying, within the obtained image, a particular region of the document having a printed authentication feature based on a spatial frequency of printed features in the particular region; (iii) compare a shape of at least one of a plurality of regularly spaced printed shapes within the identified particular region with a shape associated with an authentic version of the document; (iv) make a determination of authenticity of the imaged document based at least in part on the comparison; and (v) generate an indication of the determination.

19. The system of claim 18,
wherein the computing system comparing the shape comprises the computing system determining a degree of correspondence between one or more corners of the shape and one or more corners of the shape associated with the authentic version of the document, and
wherein the computing system making the determination of authenticity comprises the computing system making the determination of authenticity based at least in part on the estimated degree of correspondence.

20. The system of claim 18, further comprising:
a display system; and
wherein the computing system is further configured to display, via the display system, data indicative of the generated indication.
